(19) United States
(12) Patent Application Publication
(10) Pub. No.: US 2026/0278114 A1
(43) Pub. Date: Sep. 17, 2026

(54) SYSTEM AND METHOD FOR ENHANCED THREAT ANALYSIS AND RISK ASSESSMENT

(71) Applicant: TOYOTA JIDOSHA KABUSHIKI KAISHA, Toyota-shi (JP)

(72) Inventors: Nikhil MANOHAR, Tokyo (JP); Xin Huang, Kawasaki-shi (JP)

(73) Assignee: TOYOTA JIDOSHA KABUSHIKI KAISHA, Toyota-shi (JP)

(21) Appl. No.: 19/081,209

(22) Filed: Mar. 17, 2025

(51) Int. Cl. G06F 21/57; G06F 21/54

(52) U.S. Cl. CPC G06F 21/577; G06F 21/54

(57) ABSTRACT

Provided are system, method, and device for automatically enhancing threat analysis and risk assessment. According to example embodiments, the system may be configured to: obtain vehicle architecture information specifying a plurality of components in a vehicle and a plurality of connections between the plurality of components; generate a graph comprising the plurality of components and the plurality of connections; identify a path from the entry point through at least one of the plurality of connections to the asset based on the graph; obtain an attack feasibility score of the path; obtain impact assessment data of the path; obtain a risk level of the path based on the attack feasibility score of the path and the impact assessment data of the path; and obtain a mitigation strategy of the path based on the risk level of the path.

### TECHNICAL FIELD

Example embodiments of the present disclosure relate to automotive cybersecurity, and more specifically, relate to the enhancement of Threat Analysis and Risk Assessment in automotive cybersecurity.

### BACKGROUND

Modern vehicles are capable of performing a wide range of complex functions, such as generating telemetry data, transmitting and receiving data via the internet, performing driving assistance, and the like. As the functions of modern vehicles become more advanced and complex, so does the demands for more robust automotive cybersecurity in order to ensure that the vehicles operate safely and securely.

To improve security in modern vehicles, the process of Threat Analysis and Risk Assessment (TARA) has been proposed and outlined by various standard organizations, such as the International Organization for Standardization (ISO), Society of Automotive Engineers (SAE), and the like (e.g., International Organization for Standardization (ISO)/Society of Automotive Engineers (SAE) 21434).

In general, TARA may include processes involving: asset identification, threat scenario identification, impact assessment, attack path analysis, attack feasibility evaluation, risk determination, and risk treatment decision.

### SUMMARY

Example embodiments consistent with the present disclosure allows for threat analysis and risk assessment for vehicles to be performed in a quick, efficient, and error-free manner without relying on subjective opinions.

According to example embodiments, a system is provided. The system may include: a memory storage storing computer-executable instructions; and at least one processor communicatively coupled to the memory storage, wherein the at least one processor may be configured to execute the instructions to: obtain vehicle architecture information specifying a plurality of components in a vehicle and a plurality of connections between the plurality of components, wherein the plurality of components may include at least one component corresponding to an asset and at least one component corresponding to an entry point; generate a graph comprising the plurality of components and the plurality of connections; identify a path from the entry point through at least one of the plurality of connections to the asset based on the graph; obtain an attack feasibility score of the path; obtain impact assessment data of the path; obtain a risk level of the path based on the attack feasibility score of the path and the impact assessment data of the path; and obtain a mitigation strategy of the path based on the risk level of the path.

According to example embodiments, the plurality of components may include a plurality of components corresponding to a plurality of assets, and the at least one may be is configured to identify all paths from the entry point to each of the plurality of assets; the plurality of components may include a plurality of components corresponding to a plurality of entry points, and the at least one processor may be configured to identify all paths from each of the plurality of entry points to the asset; or the plurality of components may include a plurality of components corresponding to a plurality of assets and a plurality of components corresponding to a plurality of entry points, and the at least one processor may be configured to identify all paths from each of the plurality of entry points to each of the plurality of assets.

According to example embodiments, the plurality of connections may be associated with a plurality of weights representing difficulties for an attacker to traverse the corresponding connection.

According to example embodiments, the at least one processor may be configured to identify the path from the entry point to the asset based on the graph using a path finding algorithm.

According to example embodiments, the at least one processor may be configured to obtain the attack feasibility score of the path by: determining an individual attack feasibility score of each connection within the path; and aggregating all individual attack feasibility scores of all connections within the path.

According to example embodiments, the at least one processor may be configured to aggregate all individual attack feasibility scores of all connections within the path based on the following formula:

$${AS}_{Path} = SUM ( MAX ( {AS}_{Connection} ) ) \times \frac{number of connections}{maximum number of connections}$$

wherein the ASₚₐₜₕ may represent the attack feasibility score for the path, the AS_{Connection} may represent the individual attack feasibility score of each connection within the path, the number of connections may represent the total number of connections within the path, and the maximum number of connections may represent a number of connection within a path that is highest among all identified paths.

According to example embodiments, the at least one processor may be configured to obtain the mitigation strategy of the path based on the risk level of the path by: determining an individual mitigation strategy for each connection within the path based on a risk level determined based on a respective individual attack feasibility score; and combining all individual mitigation strategies of all connections within the path.

According to example embodiments, one or more of: the attack feasibility score, the impact assessment data, the risk level, and the mitigation strategy may be obtained from a user.

According to example embodiments, a method is provided. The method may include: obtaining vehicle architecture information specifying a plurality of components in a vehicle and a plurality of connections between the plurality of components, wherein the plurality of components may include at least one component corresponding to an asset and at least one component corresponding to an entry point; generating a graph comprising the plurality of components and the plurality of connections; identifying a path from the entry point through at least one of the plurality of connections to the asset based on the graph; obtaining an attack feasibility score of the path; obtaining impact assessment data of the path; obtaining a risk level of the path based on the attack feasibility score of the path and the impact assessment data of the path; and obtaining a mitigation strategy of the path based on the risk level of the path.

According to example embodiments, the plurality of components may include a plurality of components corresponding to a plurality of assets, and the method may include identifying all paths from the entry point to each of the plurality of assets; the plurality of components may include a plurality of components corresponding to a plurality of entry points, and the method may include identifying all paths from each of the plurality of entry points to the asset; or the plurality of components may include a plurality of components corresponding to a plurality of assets and a plurality of components corresponding to a plurality of entry points, and the method may include identifying all paths from each of the plurality of entry points to each of the plurality of assets.

According to example embodiments, the plurality of connections may be associated with a plurality of weights representing difficulties for an attacker to traverse the corresponding connection.

According to example embodiments, the path may be identified from the entry point to the asset based on the graph using a path finding algorithm.

According to example embodiments, the obtaining the attack feasibility score of the path may include: determining an individual attack feasibility score of each connection within the path; and aggregating all individual attack feasibility scores of all connections within the path.

According to example embodiments, all individual attack feasibility scores of all connections within the path may be aggregated based on the following formula:

$${AS}_{Path} = SUM ( MAX ( {AS}_{Connection} ) ) \times \frac{number of connections}{maximum number of connections}$$

wherein the ASₚₐₜₕ may represent the attack feasibility score for the path, the AS_{Connection} may represent the individual attack feasibility score of each connection within the path, the number of connections may represent the total number of connections within the path, and the maximum number of connections may represent a number of connection within a path that is highest among all identified paths.

According to example embodiments, the obtaining the mitigation strategy of the path based on the risk level of the path may include: determining an individual mitigation strategy for each connection within the path based on a risk level determined based on a respective individual attack feasibility score; and combining all individual mitigation strategies of all connections within the path.

According to example embodiments, one or more of: the attack feasibility score, the impact assessment data, the risk level, and the mitigation strategy may be obtained from a user.

According to example embodiments, a non-transitory computer-readable recording medium is provided. The non-transitory computer-readable recording medium may have recorded thereon instructions executable by at least one processor to cause the at least one processor to perform a method including: obtaining vehicle architecture information specifying a plurality of components in a vehicle and a plurality of connections between the plurality of components, wherein the plurality of components may include at least one component corresponding to an asset and at least one component corresponding to an entry point; generating a graph comprising the plurality of components and the plurality of connections; identifying a path from the entry point through at least one of the plurality of connections to the asset based on the graph; obtaining an attack feasibility score of the path; obtaining impact assessment data of the path; obtaining a risk level of the path based on the attack feasibility score of the path and the impact assessment data of the path; and obtaining a mitigation strategy of the path based on the risk level of the path.

According to example embodiments, the plurality of components may include a plurality of components corresponding to a plurality of assets, and the method may include identifying all paths from the entry point to each of the plurality of assets; the plurality of components may include a plurality of components corresponding to a plurality of entry points, and the method may include identifying all paths from each of the plurality of entry points to the asset; or the plurality of components may include a plurality of components corresponding to a plurality of assets and a plurality of components corresponding to a plurality of entry points, and the method may include identifying all paths from each of the plurality of entry points to each of the plurality of assets.

According to example embodiments, the plurality of connections may be associated with a plurality of weights representing difficulties for an attacker to traverse the corresponding connection.

According to example embodiments, the path may be identified from the entry point to the asset based on the graph using a path finding algorithm.

According to example embodiments, the obtaining the attack feasibility score of the path may include: determining an individual attack feasibility score of each connection within the path; and aggregating all individual attack feasibility scores of all connections within the path.

According to example embodiments, all individual attack feasibility scores of all connections within the path may be aggregated based on the following formula:

$${AS}_{Path} = SUM ( MAX ( {AS}_{Connection} ) ) \times \frac{number of connections}{maximum number of connections}$$

wherein the ASₚₐₜₕ may represent the attack feasibility score for the path, the AS_{Connection} may represent the individual attack feasibility score of each connection within the path, the number of connections may represent the total number of connections within the path, and the maximum number of connections may represent a number of connection within a path that is highest among all identified paths.

According to example embodiments, the obtaining the mitigation strategy of the path based on the risk level of the path may include: determining an individual mitigation strategy for each connection within the path based on a risk level determined based on a respective individual attack feasibility score; and combining all individual mitigation strategies of all connections within the path.

According to example embodiments, one or more of: the attack feasibility score, the impact assessment data, the risk level, and the mitigation strategy may be obtained from a user.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a flow diagram of an example method for enhancing threat analysis and risk assessment, according to one or more example embodiments;

FIG. 2 illustrate an example graph, according to one or more example embodiments;

FIG. 3 illustrates a flow diagram of an example method for determining an attack feasibility score, according to one or more example embodiments;

FIG. 4 illustrates a flow diagram of an example method for determining a mitigation strategy, according to one or more example embodiments; and

FIG. 5 illustrates a block diagram of example components in a system, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

As described above, Threat Analysis and Risk Assessment (TARA) has been proposed and outlined to improve security in modern vehicles, which may include processes involving: asset identification, threat scenario identification, impact assessment, attack path analysis, attack feasibility evaluation, risk determination, and risk treatment decision.

Asset identification may involve identification of assets, such as physical components, data, and the like, within the system (vehicle) that need protection, as well as identification of interaction points, such as interfaces and the like, which an attacker may potentially interact within in order to gain access to and exploit the assets.

Threat scenario identification may involve identification of scenarios which an attacker may exploit the assets through analysis of data and command flow in the system, potential attack paths, attack techniques, and the like.

Impact assessment may involve assessment and determination of potential impact on the safety of the system for each of the scenarios, where the safety may include various aspects, such as financial, operational, privacy, and the like.

Attack path analysis may involve identification and analysis of potential attack paths for each of the scenarios from entry points to assets. It is noted that attack path analysis may be thoroughly documented, detailing the methods and tools employed to trace paths from entry points to assets, in order to ensure transparency and repeatability in evaluating how attackers might traverse the system. Further, attack path analysis may be performed automatically using methods, such as attack tree analysis, or manually based on an analyst's experience.

Attack feasibility evaluation may involve evaluation and determination of feasibility (likelihood) of each of the scenarios based on factors, such as time, expertise, system knowledge, equipment, and the like that may be necessary for the attacker to successfully exploit the asset.

Risk determination may involve determination and establishment of risk levels for each of the scenarios based on associated impact and feasibility. The risk levels may be determined using tools, such as risk matrix, to categorize the risk levels into, for example, high risk, medium risk, low risk, and the like.

Risk treatment decision may involve determination and decision on actions (countermeasures) to perform in order to mitigate, transfer, accept, or avoid the risks based on their associated levels.

In this regard, the above described processes in the related art may have at least the following shortcomings.

The process such as threat scenario identification may be performed through a long and tedious manual process that requires understanding of assets, their scope, their interactions with each other, as well as determining how an attacker may exploit intermediate assets before reaching a target asset from an entry point in the most feasible way. In this regard, as vehicles and their functions become more complex with complex connections between system components leading to a large amount of information to process and a large number of potential attack paths, such manual process may be inefficient, time consuming, and error prone. In addition, resulting analysis may be accidently redundant due to the large amount of information to process and potential attack paths, and/or have to be repeated with each update on the input information, causing further inefficiency.

Further, the process such as attack feasibility evaluation, risk determination, and risk treatment decision may be performed based on a subjective opinion and experience of an analyst. Even though non-subjective elements may be utilized by the analyst, such as scales for attack feasibility evaluation (Common Vulnerability Scoring System (CVSS), Attack Potential, and the like), the resulting assessment may still be subjective leading to varying and inconsistent feasibility evaluation, risk levels, and suggested countermeasures for similar attack paths when analyzed by different analysts. An alternate method may involve using a disclosed vulnerability database, such as Common Vulnerabilities and Exposures (CVE) database, to provide an estimate on the feasibility/likelihood. However, such method may not be applicable to close-sourced or proprietary systems which do not disclose detailed vulnerability information. Since the TARA may be conducted at various stages of software development lifecycle, the inconsistent and subjective nature of the results may cause difficulties when comparing or merging different results.

Accordingly, there is a need for a system that is able to perform threat analysis and risk assessment for vehicles, while addressing one or more of the above mentioned shortcomings.

It is contemplated that features, advantages, and significances of example embodiments described herein are merely a portion of the present disclosure, and are not intended to be exhaustive or to limit the scope of the present disclosure. Further descriptions of the features, components, configuration, operations, and implementations of the example embodiments of the present disclosure are provided in the following.

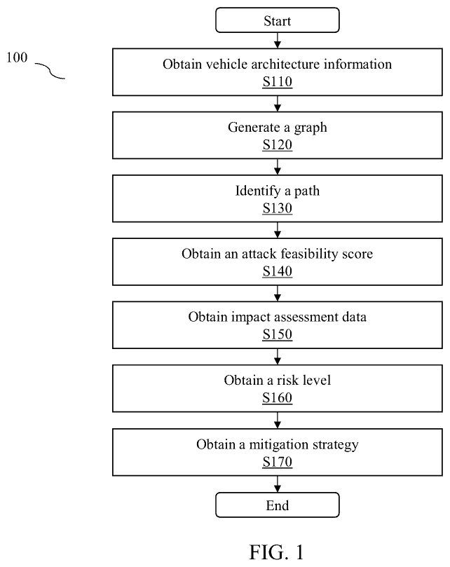

In the following, several example operations performable by a threat and risk analysis (TRA) system of the present disclosure are described with reference to FIG. 1 to FIG. 4.

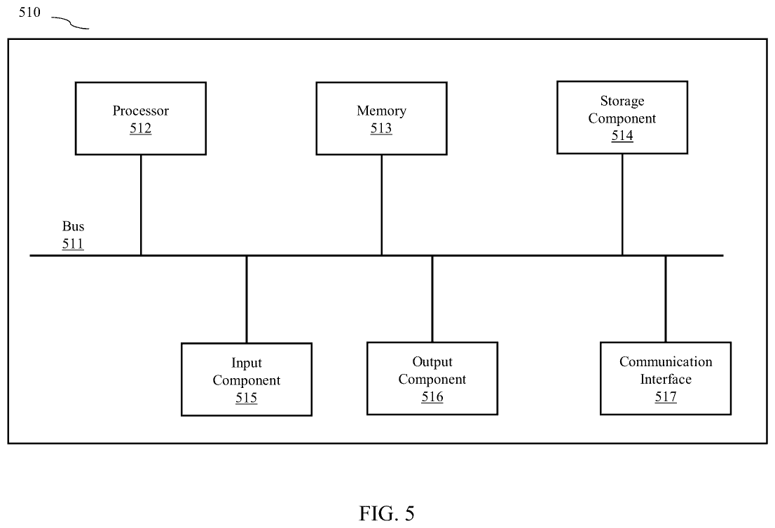

The TRA system may include an apparatus, a system, a platform, a module, or the like, which may be configured to perform one or more operations or actions for enhancing threat analysis and risk assessment in a vehicle. According to example embodiments, the TRA system may be comprised in the vehicle, or be separated from the vehicle itself. Several example components which may be included in the TRA system, according to one or more example embodiments, are described below with reference to FIG. 5.

FIG. 1 illustrates a flow diagram of an example method 100 for enhancing threat analysis and risk assessment, according to one or more example embodiments. One or more operations in method 100 may be performed by at least one processor (e.g., processor 512) of the TRA system.

As illustrated in FIG. 1, at operation S110, the at least one processor may be configured to obtain vehicle architecture information. The vehicle architecture information may include information specifying a plurality of components in a vehicle and a plurality of connections between the plurality of components.

The plurality of components may include any kind of components in a vehicle, such as physical components (Electronic Control Units (ECUs), System on Chips (SoCs), sensors, physical data storage medium, etc.), software components (software modules, applications, database, specific data within the database, etc), and the like.

Further, the plurality of components may include at least one component corresponding to an asset and at least one component corresponding to an entry point. The asset may refer to components within the vehicle that need protection from an attacker, such as personal information/data of the driver stored in the database. The entry point may refer to components within the vehicle through which the attacker may first gain access to in order to exploit the asset from outside of the vehicle, such as an application/software connected to the internet. According to example embodiments, the plurality of components may include a plurality of components corresponding to a plurality of entry points. According to example embodiments, the plurality of components may include a plurality of components corresponding to a plurality of assets.

Furthermore, according to example embodiments, the plurality of components may include at least one component corresponding to an intermediary component. The intermediary component may refer to a component within the vehicle through which the attacker may gain access to from the entry point in order to traverse and exploit the asset. In other words, the intermediary component may be between the entry point and the asset in the attack path. It is noted that, a component corresponding to an asset may also correspond to an intermediary component for another asset. According to example embodiments, the plurality of components may include a plurality of components corresponding to a plurality of intermediary components.

According to example embodiments, the vehicle architecture information may specify all components within the vehicle.

The plurality of connections may include any kind of connections (i.e., elementary connections) between any two components within the vehicle, such as interfaces (physical, logical, etc.) and the like. The plurality of connections may also be associated with and specify information related to a particular connection, such as a type of data being transmitted through the connection, a direction of the data being transmitted through the connection, an interaction between the two components using the connection, and the like.

In this regard, each of the plurality of connections may be omnidirectional or bidirectional indicating whether data and/or attack can move in one direction or both directions between components.

Further, according to example embodiments, the plurality of connections may be associated with a plurality of weights. The weight may represent a difficulty for an attacker to traverse a corresponding connection from one component to another. As such, different connections may be associated with different weights to represent the differences in difficulties for the attacker to traverse such connections thereby simulating real-world attack complexities.

According to example embodiments, the vehicle architecture information may specify all connections between the plurality of components.

According to example embodiments, the at least one processor may be configured to obtain vehicle architecture information by analyzing information associated with the architecture of the vehicle in order to identify the plurality of components and the plurality of connections.

According to example embodiments, the at least one processor may be configured to obtain vehicle architecture information by receiving the vehicle architecture information from a user (e.g., an analyst, a developer, etc.) For example, the user may provide information, such as system/vehicle architecture, entry points, assets, various relevant security measures, and the like to the TRA system. The method then proceeds to operation S120.

At operation S120, the at least one processor may be configured to generate a graph including the plurality of components and the plurality of connections.

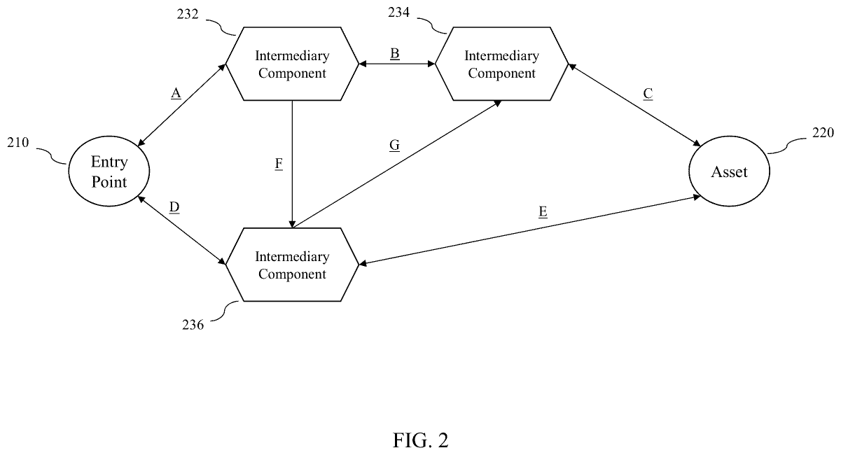

FIG. 2 illustrates an example graph, according to one or more example embodiments. As shown in FIG. 2, the graph may include a plurality of components with one component corresponding to an entry point 210, one component corresponding to an asset 220, and three components corresponding to intermediary components 232, 234, 236. Further, the graph may also include a plurality of connections A, B, C, D, E, F, and G between the plurality of components, where connections A, B, C, D, and E may be bidirectional and connections F and G may be omnidirectional.

It is understood that the configuration illustrated in FIG. 2 is simplified for descriptive purpose, and is not intended to limit the scope of the present disclosure in any way. For example, the number of components (entry point, asset, and intermediary) and connections can be any number, the connections can be between any two components, and the like. The method then proceeds to operation S130.

At operation S130, the at least one processor may be configured to identify a path from the entry point through at least one of the plurality of connections to the asset based on the graph. According to example embodiments, the at least one processor may be configured to identify all paths from the entry point through all combinations of connections to the asset based on the graph.

For example, referring to FIG. 2, the at least one processor may be configured to identify a first path from the entry point 210 through connections A, B, and C (through intermediary components 232 and 234) to the asset 220, a second path from the entry point 210 through connections D and E (through intermediary component 236) to the asset 220, a third path from the entry point 210 through connections A, F, and E (through intermediary components 232 and 236) to the asset 220, a fourth path from the entry point 210 through connections D, G, and C (through intermediary components 236 and 234) to the asset 220, and a fifth path from the entry point 210 through connections A, F, G, and C (through intermediary components 232, 236 and 234) to the asset 220.

It is noted that, since paths F and G are omnidirectional from intermediary component 232 to intermediary component 236 and from intermediary component 236 to intermediary component 234, respectively in the example of FIG. 2, the path through connections D, F, B, and C and the path through connections A, B, G, and E may not be possible. As such, said paths may not be identified during operation S130.

According to example embodiments, if the plurality of components include a plurality of components corresponding to a plurality of assets and one component corresponding to an entry point, the at least one processor may identify all paths from the entry point to each of the plurality of assets. Similarly, if the plurality of components include one component corresponding to an asset and a plurality of components corresponding to a plurality of entry points, the at least one processor may identify all paths from each of the plurality of entry points to the asset. Further, if the plurality of components include a plurality of components corresponding to a plurality of entry points and a plurality of components corresponding to a plurality of entry point, the at least one processor may identify all paths from each of the plurality of entry points to each of the plurality of assets.

According to example embodiments, the at least one processor may be configured to identify the path from the entry point through to the asset based on the graph using a path finding algorithm. The path finding algorithm may include, for example, Dijkstra's algorithm, a depth-first search (DFS), breadth-first search (BFS), and the like. In particular, for example, Dijkstra's algorithm may be utilized to identify the shortest and/or easiest (i.e., based on weights, etc.) path from an entry point to an asset, while the DFS and/or BFS may be utilized to identify all possible paths from any number of entry points to any number of assets ensuring that all paths including less direct/more complex paths are identified for analysis.

According to example embodiments, the at least one processor may be configured to identify a plurality of paths from the entry point to the asset, a plurality of paths from a plurality of entry points to the asset, a plurality of paths from the entry point to a plurality of assets, and/or a plurality of paths from a plurality of entry points to a plurality of assets. The method then proceeds to operation S140.

At operation S140, the at least one processor may be configured to obtain an attack feasibility score of the path (i.e., the path identified during operation S130). The attack feasibility score may represent a feasibility (likelihood) of the attacker exploiting the asset using the identified path.

It is understood that, if a plurality of paths are identified during operation S130, the at least one processor may obtain an attack feasibility score for each of the plurality of paths.

For example, referring to FIG. 2, the at least one processor may be configured to obtain an attack feasibility score for the first path from the entry point 210 through connections A, B, and C (through intermediary components 232 and 234) to the asset 220, an attack feasibility score for the second path from the entry point 210 through connections D and E (through intermediary component 236) to the asset 220, an attack feasibility score for the third path from the entry point 210 through connections A, F, and E (through intermediary components 232 and 236) to the asset 220, an attack feasibility score for the fourth path from the entry point 210 through connections D, G, and C (through intermediary components 236 and 234) to the asset 220, and an attack feasibility score for the fifth path from the entry point 210 through connections A, F, G, and C (through intermediary components 232, 236 and 234) to the asset 220.

According to example embodiments, the attack feasibility score may be obtained by determining the attack feasibility score automatically based on the identified path. For example, the system may utilize artificial intelligence (AI)/machine learning (ML) model trained based on historical data associated with attack feasibility scores and plurality of paths, in order to analyze and determine attack feasibility score associated with an attack via each of the identified plurality of paths. According to example embodiments, the attack feasibility score may be obtained by receiving the attack feasibility score from a user (e.g., an analyst). For example, the user may analyze and determine attack feasibility score associated with an attack via each of the identified plurality of paths (i.e., based on the identified path), and provide such attack feasibility score to the system.

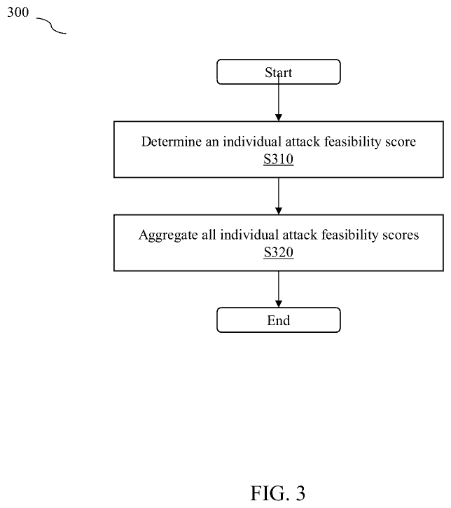

Examples of operations for obtaining an attack feasibility score are described below with reference to FIG. 3. The method then proceeds to operation S150.

At operation S150, the at least one processor may be configured to obtain impact assessment data of the path (i.e., the path identified during operation S130). The impact assessment data may include information related to a potential impact that may result from an attack via the identified path (or each of the identified plurality of paths). Further, the potential impact may include impact on the safety of the system, which may include safety associated with financial, operational, privacy, and the like.

It is understood that, if a plurality of paths are identified during operation S130, the at least one processor may obtain impact assessment data for each of the plurality of paths.

According to example embodiments, the impact assessment data may be obtained by determining the impact assessment data automatically based on the identified path. For example, the system may utilize artificial intelligence (AI)/machine learning (ML) model trained based on historical data associated with impact assessment and plurality of paths, in order to analyze and determine potential impact that may result from an attack via each of the identified plurality of paths. According to example embodiments, the impact assessment data may be obtained by receiving the impact assessment data from a user (e.g., an analyst). For example, the user may analyze and determine potential impact that may result from an attack via each of the identified plurality of paths (i.e., based on the identified path), and provide such potential impact to the system. The method then proceeds to operation S160.

At operation S160, the at least one processor may be configured to obtain a risk level of the path (i.e., the path identified during operation S130) based on the attack feasibility score of the path and the impact assessment data of the path. The risk level may indicate a level of risk associated with the identified path (or each of the identified plurality of paths).

It is understood that, if a plurality of paths are identified during operation S130, the at least one processor may obtain risk level for each of the plurality of paths based on the respective attack feasibility score and impact assessment data.

According to example embodiments, the risk level may be obtained by determining the risk level automatically based on the obtained attack feasibility score and the obtained impact assessment data. For example, the system may utilize artificial intelligence (AI)/machine learning (ML) model trained based on historical data associated with risk levels, impact assessments, and attack feasibility scores, in order to analyze and determine the risk level associated with an attack via each of the identified plurality of paths. According to example embodiments, the risk level may be obtained by receiving the risk level from a user (e.g., an analyst). For example, the user may analyze and determine the risk level associated with an attack via each of the identified plurality of paths (i.e., based on the obtained attack feasibility score and the obtained impact assessment data), and provide such risk level to the system.

According to example embodiments, the risk level may be obtained using any appropriate tools, such as risk matrix, to categorize the risk levels into, for example, high risk, medium risk, low risk, and the like, without limitation. For example, a table (2D matrix) may be utilized where the columns may represent various types of damage category, such as safety (i.e., in accordance with and as defined in one or more technical standards), financial impact, operational, privacy, and the like, and where the rows may represent various levels of risks, such as severe, major, moderate, negligible, and the like. In this regard, the entries in the table may include descriptions of attack scenario at the corresponding damage category and risk level. For example, the safety damage type and moderate risk level may correspond to an entry with description of attack scenario involving light and moderate injuries, while the operational damage type and severe risk level may correspond to an entry with description of attack scenario involving loss or impairment of a core vehicle function. The method then proceeds to operation S170.

At operation S170, the at least one processor may be configured to obtain a mitigation strategy of the path (i.e., the path identified during operation S130) based on the risk level of the path. The mitigation strategy may refer to a strategy for mitigating, avoiding, controlling, and the like for the attacker to exploit the asset using the path.

It is understood that, if a plurality of paths are identified during operation S130, the at least one processor may obtain a mitigation strategy for each of the plurality of paths based on the respective risk level.

For example, referring to FIG. 2, the at least one processor may be configured to obtain a mitigation strategy for the first path from the entry point 210 through connections A, B, and C (through intermediary components 232 and 234) to the asset 220, a mitigation strategy for the second path from the entry point 210 through connections D and E (through intermediary component 236) to the asset 220, a mitigation strategy for the third path from the entry point 210 through connections A, F, and E (through intermediary components 232 and 236) to the asset 220, a mitigation strategy for the fourth path from the entry point 210 through connections D, G, and C (through intermediary components 236 and 234) to the asset 220, and a mitigation strategy for the fifth path from the entry point 210 through connections A, F, G, and C (through intermediary components 232, 236 and 234) to the asset 220.

According to example embodiments, the mitigation strategy may be obtained based on any additional information associated with attack mitigation strategies. For example, the mitigation strategy may be obtained additionally based on information related to industry best practices for the type of connections present in the attack path, expert's knowledge, historical data, and the like. In a further example, different mitigation strategies may be obtained and utilized for different type of connections (e.g., Bluetooth connection vs CAN connection vs Wi-Fi connection).

According to example embodiments, the mitigation strategy may be obtained by determining the mitigation strategy automatically based on the risk level of the path. For example, the system may utilize artificial intelligence (AI)/machine learning (ML) model trained based on historical data associated with mitigation strategies and risk levels, in order to analyze and determine mitigation strategy associated with an attack via each of the identified plurality of paths according to the corresponding risk level. According to example embodiments, the mitigation strategy may be obtained by receiving the mitigation strategy from a user (e.g., an analyst). For example, the user may analyze and determine mitigation strategy associated with an attack via each of the identified plurality of paths according to the corresponding risk level (i.e., based on the risk level), and provide such mitigation strategy to the system.

According to example embodiments, the mitigation strategy may be obtained for a path that has a risk level above a predetermined threshold. For example, if the predetermined threshold is 3, while the first path has a risk level of 2 and the second path has a risk level of 5, the mitigation strategy may be obtained for the second path which has the risk level above the threshold, and the mitigation strategy may not be obtained for the first path which has the risk level below the threshold.

According to example embodiments, for example, stricter mitigation may be obtained for higher risk levels, while simpler or no mitigation may be obtained for lower risk levels.

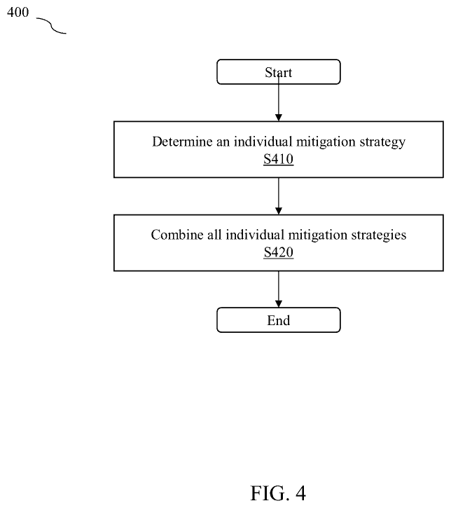

Examples of operations for obtaining a mitigation strategy are described below with reference to FIG. 4.

Upon performing operation S170, the method 100 may be ended or be terminated. Alternatively, method 100 may return to operation S110, such that the at least one processor may be configured to repeatedly perform, for at least a predetermined amount of time, the obtaining the vehicle architecture information (at operation S110), the generating the graph (at operation S120), the identifying the path (at operation S130), the obtaining the attack feasibility score (at operation S140), the obtaining the impact assessment data (at operation S150), the obtaining the risk level (at operation S160), and the obtaining the mitigation strategy (at operation S170).

Accordingly, the above configuration allows for threat analysis and risk assessment for vehicles to be performed in a quick, efficient, and error-free manner without relying on subjective opinions.

In particular, the use of the graph facilitates and simplifies identification of all possible attack paths from all entry points to all vulnerable assets, and subsequently enables identification of the most feasible attack path based on factors, such as attack feasibility scores, connection weights, and the like in a quick, efficient, and error-free manner.

Further, by having the above processes be performed by a system automatically, the above processes streamline the threat analysis and risk assessment, reduce manual effort and subjective opinion, and ensure consistency in the results.

In addition, according to example embodiments, all operations described above in relation to method 100 may be performed by the system (i.e., TRA system) automatically. According to example embodiments, one or more operations described above in relation to method 100 may be performed by a user (e.g., an analyst, a developer, etc.) For example, the obtaining the vehicle architecture information (at operation S110), the generating the graph (at operation S120), and the identifying the path (at operation S130) may be performed automatically by the system, while one or more of the obtaining the attack feasibility score (at operation S140), the obtaining the impact assessment data (at operation S150), the obtaining the risk level (at operation S160), and the obtaining the mitigation strategy (at operation S170) may be performed by a user (i.e., where the system may receive the above parameters from the user). In other words, according to example embodiments, one or more of: the attack feasibility score, the impact assessment data, the risk level, and the mitigation strategy may be obtained (receive) from a user.

FIG. 3 illustrates a flow diagram of an example method 300 for obtaining an attack feasibility score, according to one or more example embodiments. One or more operations of method 300 may be part of operation S140 in method 100, and may be performed by at least one processor (e.g., processor 512) of the TRA system.

As illustrated in FIG. 3, at operation S310, the at least one processor may be configured to determine an individual attack feasibility score of each connection within the path. Here, the path may refer to the path identified during operation S130 in method 100.

For example, referring to FIG. 2, the at least one processor may be configured to determine individual attack feasibility scores for each of connections A, B, and C for the first path (from the entry point 210 through connections A, B, and C (through intermediary components 232 and 234) to the asset 220).

According to example embodiments, the individual attack feasibility score may be determined based on a security evaluation method, such as, for example, Common Vulnerability Scoring System (CVSS), Attack Potential, Attack Vector and the like defined in accordance with one or more technical standards of International Organization for Standardization (ISO).

According to example embodiments, the individual attack feasibility score may be further scaled based on the weight associated with the corresponding connection. Such scaling may improve the accuracy and facilitate the determination of the individual attack feasibility score, as the difficulty for traversing the connection may affect the likelihood of an attack. The method then proceeds to operation S320.

At operation S320, the at least one processor may be configured to aggregate all individual attack feasibility scores of all connections within the path.

For example, referring to FIG. 2, the at least one processor may be configured to aggregate the individual attack feasibility scores of connections A, B, and C for the first path (from the entry point 210 through connections A, B, and C (through intermediary components 232 and 234) to the asset 220).

According to example embodiments, the at least one processor may be configured to aggregate all individual attack feasibility scores of all connections within the path based on the following formula:

$${AS}_{Path} = SUM ( MAX ( {AS}_{Connection} ) ) \times \frac{number of connections}{maximum number of connections}$$

Here, the ASₚₐₜₕ may represent the attack feasibility score for the path (i.e., the aggregated individual attack feasibility scores), the AS_{connection} may represent the individual attack feasibility score of each connection within the path (determined during operation S310 using the security evaluation method Common Vulnerability Scoring System (CVSS), Attack Potential, Attack Vector, etc.), the number of connections may represent the total number of connections within the path, and the maximum number of connections may represent a number of connection within a path that is highest among all identified paths (all paths identified during operation S130).

For example, referring to FIG. 2, when aggregating all individual attack feasibility scores of all connections within the first path (from the entry point 210 through connections A, B, and C (through intermediary components 232 and 234) to the asset 220), the ASₚₐₜₕ may represent the attack feasibility score for the first path, the AS_{connection} represents the individual attack feasibility score of each of connections A, B, and C within the first path, and the number of connections may correspond to 3 representing the total number of connections A, B, and C within the first path. Here, the fifth path may be identified during operation S130 as the path that has a number of connection (4 connections for A, F, G, and C) that is the highest among all identified first, second, third, fourth, and fifth paths. As such, the maximum number of connections may correspond to 4 representing a number of connection within a path that is highest among all identified paths.

The maximum number of connections may serve as a reference point for normalizing the attack feasibility score across different threat scenarios, ensuring consistent evaluation across varying levels of complexity in the architecture.

According to example embodiments, one or more operations in method 300 may be performed automatically by the system According to example embodiments, one or more operations in method 300 may be performed by a user (e.g., analyst), where the system may receive corresponding parameters from the user. For example, the user may determine the individual attack feasibility score in the similar manner as described above in relation to operation S310. The user may then provide the determined individual attack feasibility score to the system, where the system may then aggregate all individual attack feasibility scores in the similar manner as described above in relation to operation S320. In another example, the user may determine the individual attack feasibility score in the similar manner as described above in relation to operation S310, as well as aggregate all individual attack feasibility scores in the similar manner as described above in relation to operation S320. The user may then provide the aggregated individual attack feasibility scores to the system.

Accordingly, the above calculation may provide a comprehensive assessment of the attack feasibility across different paths, incorporating both the complexity of the scenario and the relative difficulty of each connection.

Further, the above formula may be compatible with various security evaluation methods, such as the Attack Potential defined in accordance with one or more technical standards of ISO, such that the above process ensures that the attack feasibility score for the path (i.e., the aggregated individual attack feasibility scores) accurately reflects the cumulative risks associated with each connection while adhering to guidelines provided by one or more technical standards.

It is understood that the above formula is provided as an example, and the present invention is not limited thereto and can encompass any kind of formula for aggregating all individual attack feasibility scores.

FIG. 4 illustrates a flow diagram of an example method 400 for obtaining a mitigation strategy, according to one or more example embodiments. One or more operations of method 400 may be part of operation S170 in method 100, and may be performed by at least one processor (e.g., processor 512) of the TRA system.

As illustrated in FIG. 4, at operation S410, the at least one processor may be configured to determine an individual mitigation strategy for each connection within the path. The individual mitigation strategy may be determined based on a respective risk level (which may be determined based on a respective individual attack feasibility score). Here, the path may refer to the path identified during operation S130 in method 100.

For example, referring to FIG. 2, the at least one processor may be configured to determine individual mitigation strategies for each of connections A, B, and C for the first path (from the entry point 210 through connections A, B, and C (through intermediary components 232 and 234) to the asset 220), where the individual mitigation strategy for connection A may be determined based on the risk level that may be determined based on the individual attack feasibility score of connection A, the individual mitigation strategy for connection B may be determined based on the risk level that may be determined based on the individual attack feasibility score of connection B, and the individual mitigation strategy for connection C may be determined based on the risk level that may be determined based on the individual attack feasibility score of connection C.

According to example embodiments, the individual mitigation strategy may be determined using an artificial intelligence (AI)/machine learning (ML) model. For example, the AI/ML model may be trained based on previous records of mitigation strategies applied to various connections between various components at various risk levels, such that the AI/ML model may be utilized to determine an appropriate mitigation strategy for the current connection at the current risk level. The method then proceeds to operation S420.

At operation S420, the at least one processor may be configured to combine all individual mitigation strategies of all connections within the path. The individual mitigation strategies may be combined to form a holistic set of guidance of the path. Such holistic set of guidance of the path may represent or indicate a comprehensive threat scenario.

According to example embodiments, one or more operations in method 400 may be performed automatically by the system According to example embodiments, one or more operations in method 400 may be performed by a user (e.g., analyst), where the system may receive corresponding parameters from the user. For example, the user may determine the individual mitigation strategy in the similar manner as described above in relation to operation S410. The user may then provide the determined individual mitigation strategy to the system, where the system may then aggregate all individual mitigation strategies in the similar manner as described above in relation to operation S420. In another example, the user may determine the individual mitigation strategy in the similar manner as described above in relation to operation S410, as well as aggregate all individual mitigation strategies in the similar manner as described above in relation to operation S420. The user may then provide the aggregated individual mitigation strategies to the system.

Accordingly, the above processes enable simplification of the determination for overall feasibility of an attack and collating possible mitigation strategies for identified issues within the attack path by constructing the overall feasibility and mitigation strategy from individual feasibility and mitigation strategy of each elementary connection.

Further, since the overall feasibility and mitigation strategy of an attack is constructed from individual feasibility and mitigation strategy of each elementary connections, the overall feasibility and mitigation strategy may be deconstructed into the feasibility and mitigation strategy of each elementary connection.

In certain implementations involving an analyst (user), the deconstruction of the elementary connections enables the analyst to focus on a smaller-scale problem when deciding the attack feasibility rating or providing suggested strategy. Since the problem each analyst needs to solve is more focused and specific, the above process reduces the subjective factors involved in the results, leading to more consistent and objective assessments, thereby further improving the quality of the analysis and assessment. Further, the above process also restricts the impact of individual perceptions of attack potential to the elementary connections, while also allows various analysts to concentrate on certain part of the system (connection) with which they are most familiar based on their area of expertise when determining feasibility and mitigation strategy thereby facilitating collaboration between analysts from different backgrounds rather than having one analyst analyzing an entire end-to-end attack scenario and requiring knowledge from multiple areas of expertise.

In addition, the deconstruction of the elementary connections also enables the threat analysis and risk assessment to be performed on a modular basis. Such modularity allows a separate threat analysis and risk assessment may be performed while incorporating new information with a new scope and while reusing certain existing information from the previous threat analysis and risk assessment, as well as allow merging of multiple threat analysis and risk assessments into a larger framework (e.g., system-level threat analysis and risk assessments). Further, the modularity also enables comparison of results from threat analysis and risk assessments performed at different times or by different teams, as well as enables easy regeneration of the process when updated input information is received at a later point in time. Such flexibility enhances the efficiency, adaptability, and traceability of threat analysis and risk assessment processes, enabling more comprehensive threat assessments across various system levels.

FIG. 5 illustrates a block diagram of example components in a system 500, according to one or more example embodiments. The system 500 may correspond to the TRA system, thus the features associated with the TRA system and the system 500 may be similarly applicable to each other, unless being explicitly described otherwise.

As illustrated in FIG. 5, the system 510 may include at least one bus 511, at least one processor 512, at least one memory 513, at least one storage component 514, at least one input component 515, at least one output component 516, and at least one communication interface 517.

It is contemplated that the system 510 may include more or less components than illustrated in FIG. 5, without departing from the scope of the present disclosure. For instance, in some embodiments, the system 510 may include a plurality of storage components 514, the input component 515 and the output component 516 may be implemented as a transceiver component, the memory 513 and storage component 514 may be implemented as a memory storage, and the like.

The bus 511 may be configured to facilitate or enable communications among the components of the system 510. Specifically, the bus 511 may communicatively couple the components to each other and provide a means for data transfer and flow of control signals between the components. The bus 511 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 510 to enable communication and coordination between the components within the system 510 in real-time (or near real-time).

The processor 512 may be implemented in hardware, firmware, or a combination of hardware and software, and may be configured to handle real-time (or near real-time) data processing and control of the control system 510. The processor 512 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 510. In some implementations, the processor 512 may be capable of being programmed to perform one or more operations described herein. Further, the processor 512 may include a plurality of processing units, each of which is dedicated to performing a specific operation.

The memory 513 may include one or more mediums for storing temporary data, runtime variables, program instructions, and buffers required for the operations of the control system 510. The memory 513 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 510 to store information and/or instructions for use by the processor 512.

The storage component 514 may be configured to store non-volatile data, such as firmware, configuration settings, calibration data, information, and/or software related to the operation and use of the system 510. For example, the storage component 514 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to example embodiments, the storage component 514 may be configured to store computer-readable or computer-executable instructions for implementing one or more operations of the system 510. The storage component 514 may provide the stored information to the memory 513 for the execution of the processor 512.

The input component 515 may include one or more input components that permit the system 510 to receive information, such as via user input (e.g., a touch screen display, a keyboard, a keypad, a mouse, a button, a switch, and/or a microphone). The output component 516 may include one or more output components that provide output information from the system 510 (e.g., a display, a speaker, a navigation device, one or more light-emitting diodes (LEDs), etc.) According to example embodiments, the input component 515 and/or the output component 516 may be optional and may be excluded from the system 510.

The at least one communication interface 517 may include a transceiver-like component (e.g., a transceiver and/or a separate receiver and transmitter) that enables the system 510 to communicate with other components (e.g., ECUs, user devices, etc.), such as via a wired connection, a wireless connection, or a combination of wired and wireless connections. For example, communication interface 517 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 517 may include at least one input/output (I/O) interface, at least one network interface, at least one storage interface, or the like, that enable the components 512-516 to communicate with other components. Further, the communication interface 517 may include one or more application programming interfaces (APIs) that allow the system 510 (or one or more components included therein) to communicate with one or more software applications (e.g., software application deployed in the ECUs, etc.)

Computer-executable instructions (e.g., software instructions, etc.) may be read into memory 513 and/or storage component 514 from another computer-readable medium or from another device (e.g., a remote server, an external storage, etc.) via, for example, the communication interface 517. When executed, the computer-executable instructions stored in memory 513 and/or storage component 514 may cause the processor 512 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A system comprising:
a memory storage storing computer-executable instructions; and
at least one processor communicatively coupled to the memory storage, wherein the at least one processor is configured to execute the instructions to:
obtain vehicle architecture information specifying a plurality of components in a vehicle and a plurality of connections between the plurality of components, wherein the plurality of components comprises at least one component corresponding to an asset and at least one component corresponding to an entry point;
generate a graph comprising the plurality of components and the plurality of connections;
identify a path from the entry point through at least one of the plurality of connections to the asset based on the graph;
obtain an attack feasibility score of the path
obtain impact assessment data of the path;
obtain a risk level of the path based on the attack feasibility score of the path and the impact assessment data of the path; and
obtain a mitigation strategy of the path based on the risk level of the path.

2. The system according to claim 1, wherein:
the plurality of components comprises a plurality of components corresponding to a plurality of assets, and the at least one processor is configured to identify all paths from the entry point to each of the plurality of assets;
the plurality of components comprises a plurality of components corresponding to a plurality of entry points, and the at least one processor is configured to identify all paths from each of the plurality of entry points to the asset; or
the plurality of components comprises a plurality of components corresponding to a plurality of assets and a plurality of components corresponding to a plurality of entry points, and the at least one processor is configured to identify all paths from each of the plurality of entry points to each of the plurality of assets.

3. The system according to claim 1, wherein the plurality of connections are associated with a plurality of weights representing difficulties for an attacker to traverse the corresponding connection.

4. The system according to claim 1, wherein the at least one processor is configured to identify the path from the entry point to the asset based on the graph using a path finding algorithm.

5. The system according to claim 1, wherein the at least one processor is configured to obtain the attack feasibility score of the path by: determining an individual attack feasibility score of each connection within the path; and aggregating all individual attack feasibility scores of all connections within the path.

6. The system according to claim 5, wherein the at least one processor is configured to aggregate all individual attack feasibility scores of all connections within the path based on the following formula:
$${AS}_{Path} = SUM ( MAX ( {AS}_{Connection} ) ) \times \frac{number of connections}{maximum number of connections}$$
wherein the ASₚₐₜₕ represents the attack feasibility score for the path, the AS_{Connection} represents the individual attack feasibility score of each connection within the path, the number of connections represents the total number of connections within the path, and the maximum number of connections represents a number of connections within a path that is highest among all identified paths.

7. The system according to claim 5, wherein the at least one processor is configured to obtain the mitigation strategy of the path based on the risk level of the path by: determining an individual mitigation strategy for each connection within the path based on a risk level determined based on a respective individual attack feasibility score; and combining all individual mitigation strategies of all connections within the path.

8. The system according to claim 1, wherein one or more of: the attack feasibility score, the impact assessment data, the risk level, and the mitigation strategy is obtained from a user.

9. A method comprising:
obtaining vehicle architecture information specifying a plurality of components in a vehicle and a plurality of connections between the plurality of components, wherein the plurality of components comprises at least one component corresponding to an asset and at least one component corresponding to an entry point;
generating a graph comprising the plurality of components and the plurality of connections;
identifying a path from the entry point through at least one of the plurality of connections to the asset based on the graph;
obtaining an attack feasibility score of the path;
obtaining impact assessment data of the path;
obtaining a risk level of the path based on the attack feasibility score of the path and the impact assessment data of the path; and
obtaining a mitigation strategy of the path based on the risk level of the path.

10. The method according to claim 9, wherein:
the plurality of components comprises a plurality of components corresponding to a plurality of assets, and the method comprises identifying all paths from the entry point to each of the plurality of assets;
the plurality of components comprises a plurality of components corresponding to a plurality of entry points, and the method comprises identifying all paths from each of the plurality of entry points to the asset; or
the plurality of components comprises a plurality of components corresponding to a plurality of assets and a plurality of components corresponding to a plurality of entry points, and the method comprises identifying all paths from each of the plurality of entry points to each of the plurality of assets.

11. The method according to claim 9, wherein the plurality of connections are associated with a plurality of weights representing difficulties for an attacker to traverse the corresponding connection.

12. The method according to claim 9, wherein the path is identified from the entry point to the asset based on the graph using a path finding algorithm.

13. The method according to claim 9, wherein the obtaining the attack feasibility score of the path comprises: determining an individual attack feasibility score of each connection within the path; and aggregating all individual attack feasibility scores of all connections within the path.

14. The method according to claim 13, wherein all individual attack feasibility scores of all connections within the path are aggregated based on the following formula:
$${AS}_{Path} = SUM ( MAX ( {AS}_{Connection} ) ) \times \frac{number of connections}{maximum number of connections}$$
wherein the AS_{Path} represents the attack feasibility score for the path, the AS_{Connection} represents the individual attack feasibility score of each connection within the path, the number of connections represents the total number of connections within the path, and the maximum number of connections represents a number of connections within a path that is highest among all identified paths.

15. The method according to claim 13, wherein the obtaining the mitigation strategy of the path based on the risk level of the path comprises: determining an individual mitigation strategy for each connection within the path based on a risk level determined based on a respective individual attack feasibility score; and combining all individual mitigation strategies of all connections within the path.

16. The method according to claim 9, wherein one or more of: the attack feasibility score, the impact assessment data, the risk level, and the mitigation strategy is obtained from a user.

17. A non-transitory computer-readable recording medium having recorded thereon instructions executable by at least one processor to cause the at least one processor to perform a method comprising:
obtaining vehicle architecture information specifying a plurality of components in a vehicle and a plurality of connections between the plurality of components, wherein the plurality of components comprises at least one component corresponding to an asset and at least one component corresponding to an entry point;
generating a graph comprising the plurality of components and the plurality of connections;
identifying a path from the entry point through at least one of the plurality of connections to the asset based on the graph;
obtaining an attack feasibility score of the path;
obtaining impact assessment data of the path;
obtaining a risk level of the path based on the attack feasibility score of the path and the impact assessment data of the path; and
obtaining a mitigation strategy of the path based on the risk level of the path.

18. The non-transitory computer-readable recording medium according to claim 17, wherein:
the plurality of components comprises a plurality of components corresponding to a plurality of assets, and the method comprises identifying all paths from the entry point to each of the plurality of assets;
the plurality of components comprises a plurality of components corresponding to a plurality of entry points, and the method comprises identifying all paths from each of the plurality of entry points to the asset; or
the plurality of components comprises a plurality of components corresponding to a plurality of assets and a plurality of components corresponding to a plurality of entry points, and the method comprises identifying all paths from each of the plurality of entry points to each of the plurality of assets.

19. The non-transitory computer-readable recording medium according to claim 17, wherein the plurality of connections are associated with a plurality of weights representing difficulties for an attacker to traverse the corresponding connection.

20. The non-transitory computer-readable recording medium according to claim 17, wherein the path is identified from the entry point to the asset based on the graph using a path finding algorithm.

21. The non-transitory computer-readable recording medium according to claim 17, wherein the obtaining the attack feasibility score of the path comprises: determining an individual attack feasibility score of each connection within the path; and aggregating all individual attack feasibility scores of all connections within the path.

22. The non-transitory computer-readable recording medium according to claim 21, wherein all individual attack feasibility scores of all connections within the path are aggregated based on the following formula:
$${AS}_{Path} = SUM ( MAX ( {AS}_{Connection} ) ) \times \frac{number of connections}{maximum number of connections}$$
wherein the ASₚₐₜₕ represents the attack feasibility score for the path, the AS_{Connection} represents the individual attack feasibility score of each connection within the path, the number of connections represents the total number of connections within the path, and the maximum number of connections represents a number of connections within a path that is highest among all identified paths.

23. The non-transitory computer-readable recording medium according to claim 21, wherein the obtaining the mitigation strategy of the path based on the risk level of the path comprises: determining an individual mitigation strategy for each connection within the path based on a risk level determined based on a respective individual attack feasibility score; and combining all individual mitigation strategies of all connections within the path.

24. The non-transitory computer-readable recording medium according to claim 17, wherein one or more of: the attack feasibility score, the impact assessment data, the risk level, and the mitigation strategy is obtained from a user.
